(19) United States
(12) Patent Application Publication
(10) Pub. No.: US 2014/0168333 A1
(43) Pub. Date: Jun. 19, 2014

(54) Dispersion, Ink and Process

(71) Applicant: Fujifilm Imaging Colorants Limited, Manchester (GB)

(72) Inventor: Gavin WRIGHT, Manchester (GB)

(21) Appl. No.: 14/105,302

(22) Filed: Dec. 13, 2013

(30) Foreign Application Priority Data
Dec. 13, 2012 (GB) 1222447.3

(51) Int. Cl. C09D 11/00; B41J 2/175

(52) U.S. Cl. CPC C09D 11/36; B41J 2/175
USPC 347/100; 524/104

(57) ABSTRACT

A dispersion comprising a particulate solid, a liquid vehicle and a first polymer, wherein: the first polymer is obtained or obtainable by a process comprising reacting at least the components i), ii) and optionally iii) to form a pre-polymer:
i) a compound of the Formula (1);

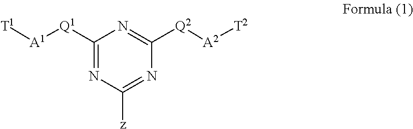

wherein T¹, T², Q¹, Q², A¹, A² and Z are as defined in claim 1;
ii) a diisocyanate;
iii) an isocyanate-reactive compound;
   and then reacting the pre-polymer with at least component iv):
iv) one or more compounds selected from an organic amine, alcohol or thiol provided that at least one of the said one or more organic compounds in component iv) has at least one ionic group; wherein the particulate solid is surface-modified with ionic groups and/or the particulate solid has situated on its surface one or more second polymers which is/are different from the first polymer.

This invention relates to dispersions and to their preparation and use in ink jet printing inks.

Pigment-based inks comprise a dispersion of pigment particles suspended in a liquid vehicle. To obtain stable pigment dispersions with a particle size sufficiently small for good ink properties two main categories of technical approaches are known in the art.

The first category utilises polymers which are situated on the surface of the pigment particles and thereby provide colloidal stability in liquid vehicles. Many methods of situating the polymer on the surface of the pigment particles are known. The simplest and most widely practiced method is to comminute (e.g. mill) a mixture of a pigment, a liquid vehicle and a polymer. In some variations of this approach the polymer is subsequently cross-linked so as to encapsulate each pigment particle within a cross-linked polymer shell. Another method is to “in situ” polymerise monomers and thereby form a polymer in the presence of a pigment dispersed in a liquid vehicle. A further method is “phase inversion dispersion” wherein typically a polymer is dispersed into a first liquid vehicle (which is often a water-miscible organic vehicle) along with the pigment and then the first liquid vehicle is dispersed into a second liquid vehicle (which is often water). Subsequently the first liquid is removed. In all of these approaches in the first category the polymer is adsorbed onto the pigment particle surface. To put it another way, in this category there is no chemical attachment of the polymer to the pigment surface.

A second category is to surface modify the pigment particles. Typically this is done by chemically attaching dispersing groups and especially water-dispersing groups to the pigment surface. The most common form of chemical attachment is to covalently bond a dispersing group to the pigment. The attachment may be either directly or via a spacer. The spacer can be a simple organic group or a more complex polymeric chain. Pigments of this kind can be made by performing sulfonation, chlorosulfonation or ozone treatment of a conventional pigment, or by reacting such a pigment with hypohalous acids or with a diazonium compound.

Whichever of the above technical approaches is used, the present inventors have found that it was very difficult to obtain inks which provide prints having high optical density and good adherence properties, preferably while also improving resistance properties to some extent. Resistance properties include highlighter smear fastness. It is especially difficult to provide such properties over a range of different printing substrates (e.g. different kinds of paper).

As an example, inks containing pigments having covalently attached dispersing groups may provide prints which have high optical density, but the prints often have poor adherence and resistance properties.

Inks containing pigments which are stabilised by polymers situated on the pigment surface may provide prints having good optical density, but the ink may suffer from low stability, low adherence to substrates and low resistance properties, particularly when the ratio of the polymer to pigment is low. As the ratio of polymer to pigment is increased the adherence and resistance properties improve, but typically this is at the expense of optical density which falls.

Polymeric binders may be added to dispersions and inks in order to improve the adherence and print resistance properties. The present inventors found that known binders tended to reduce optical density whilst promoting adherence and resistance. Also the present inventors often found that only small amounts of binders could be added before the binder raised the dispersion or ink viscosity too high or before printer operability issues arose. This limited the benefits of the binder as only small amounts could be incorporated.

Also the present inventors found that known binders often performed well on some substrates but poorly on others.

WO2009/115831 describes the use of polyurethanes binders in pigment-based inks.

JP2004-315716 describes pigment dispersants containing triazine groups for use in non-aqueous liquid vehicles.

According to a first aspect of the present invention there is provided a dispersion comprising a particulate solid, a liquid vehicle and a first polymer, wherein:

the first polymer is obtained or obtainable by a process comprising reacting at least the components i), ii) and optionally iii) to form a pre-polymer:
i) a compound of the Formula (1);

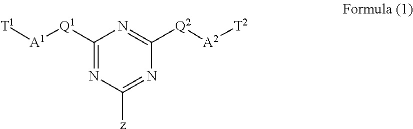

wherein:
T¹ and T² are each independently —OH, —SH or —NR¹H;
Q¹ and Q² independently are —NR²—;
A¹ and A² independently are an optionally substituted divalent organic linking group;
z is a halogen;
R¹ when present is H or an optionally substituted alkyl, aryl or heterocyclyl group;
R² is H or an optionally substituted alkyl, aryl or heterocyclyl group;
ii) a diisocyanate;
iii) an isocyanate-reactive compound;
   and then reacting the pre-polymer with at least component iv):
iv) one or more compounds selected from an organic amine, alcohol or thiol, provided that at least one of the said one or more organic compounds in component iv) has at least one ionic group;
   wherein the particulate solid is surface-modified with ionic groups and/or the particulate solid has situated on its surface one or more second polymers which is/are different from the first polymer.

Unless stated to the contrary, in the present patent the words “a” and “an” are meant to include the possibility of using one or more of that item. For example, “a” compound of Formula (1) means one or more compounds of Formula (1). Similarly, “a” diisocyanate means one or more diisocyanates.

Whilst the compounds as described in the first aspect of the present invention have been drawn in one structural formula the compounds and the scope of the claims are also intended to cover tautomers and optical isomers thereof.

Preferably the compound of Formula (1) is free from ionic groups. This helps to prevent gelation, or branching, and assists the preparation of the pre-polymer and preferred first polymer having a preferred linear structure. Preferably, the only hydroxyl, thiol or amine groups present in the compound of Formula (1) are those possible from the T¹ and T² groups.

Preferably T¹ and T² are each independently —OH or —NR¹H, more preferably T¹ and T² are —OH. Accordingly, it is preferred that the compound of Formula (1) is a diamine or a diol, more preferably a diol. When T¹ and T² are both —OH the pre-polymer and the first polymer are polyurethanes due to the reaction of components i) and ii) and optionally iii) (when present).

When T¹ and/or T² is —NR¹H it is preferred that the reactivity of this group is relatively low towards halo triazines when compared to amine groups in general. One way of achieving the desired lower reactivity is to use primary amines wherein R¹ is H. In such a case it is often desirable that R² is not H but is optionally substituted alkyl, aryl or heterocyclyl.

When an R¹ or R² group is an optionally substituted alkyl group, it is preferably optionally substituted C₁₋₂₀ alkyl.

When an R¹ or R² group is an optionally substituted aryl group it is preferably an optionally substituted phenyl or naphthyl group.

When an R¹ or R² group is an optionally substituted heterocyclyl group it may be aromatic (heteroaryl) or non aromatic. When R¹ or R² is heterocyclyl it preferably comprises a 5- or 6-membered ring containing from 1 to 3 atoms selected from N, S and O in the ring and the remaining ring atoms are carbon atoms.

Preferred examples of heterocyclyl groups include optionally substituted pyrrolyl, thiophenyl, furanyl, pyridyl, pyrimidyl, pyrazinyl, triazinyl, imidazolyl, thiazolyl, oxazolyl and pyrazolyl.

Preferably R² is H. This is especially so when T¹ and T² are both —OH.

When R¹ or R² is not H, the optional substituents for R¹ or R² are preferably each independently selected from —NO₂, CN, halo (especially Cl, F, Br and I), —NHC(O)C₁₋₆alkyl, —SO₂NHC₁₋₆alkyl, —SO₂C₁₋₆alkyl, —C₁₋₆alkyl, —OC₁₋₆alkyl, —OC(O)C₁₋₆alkyl, polypropyleneoxide ending in a C₁₋₆ alkyl group, polyethyleneoxide ending in a C₁₋₆ alkyl group. It is preferred that all of the R¹ and R² groups are free from ionic, thiol, amine, hydrazo (H₂NNH—) and hydroxyl (HO—) groups. We have found that when the R¹ and R² are free from such groups, the likelihood of unwanted gelation in the subsequent reaction with the diisocyanate in component ii) is greatly reduced.

The optional substituents described above for R¹ and R² may also be used as the optional substituents for any other group mentioned in this specification as being optionally substituted. Thus, for example, the optional substituents for A¹ and A² are preferably each independently selected from the optional substituents described above for R¹ and R².

Preferably each R² group independently is H or C₁₋₆ alkyl group, more preferably all the R² groups are H. When all the R² groups are H this means the compound of Formula (1) may be prepared from compounds which have a primary amine group. We have found that the primary amines react efficiently with halo triazines and this often allows the compound of Formula (1) to be prepared in good yield and purity.

A¹ and A² are preferably optionally substituted alkylene, cycloalkylene, arylene or heterocyclylene. Of these, optionally substituted alkylene groups are preferred. The heterocyclylene groups may be aromatic or non-aromatic. The groups A¹ and A² may be combinations of two or more groups selected from alkylene, arylene and heterocyclylene groups, optionally interrupted by groups such as —O—, —S—, —CO₂—, —NHCO—, —SO₂— and/or —NHSO₂—.

Preferably A¹ and A² are each independently an optionally substituted arylene or alkylene group or a combination thereof. A¹ and A² may be optionally substituted with one or more of the optional substituents as mentioned above for R¹ and R². In some embodiments A¹ and/or A² is/are unsubstituted.

Preferably both of the groups A¹ and A² are free from ionic, amine, hydrazo (H₂NNH—) thiol or hydroxyl groups (other than the amine groups represented by T¹, T², Q¹ and Q²). This helps to prevent any gelation in the subsequent reaction with the diisocyanate in component ii).

When A¹ or A² is optionally substituted arylene it is preferably optionally substituted naphthylene or phenylene. When A¹ is optionally substituted phenylene the groups T¹ and Q¹ may be arranged in an ortho, meta or more preferably a para position relative to each other. The same is preferred for A² wherein the corresponding groups are T² and Q².

When A¹ or A² is an optionally substituted alkylene group it is preferably a C₁₋₃₀ alkylene group, especially a C₁₋₂₀ alkylene group and most especially a C₂₋₈ alkylene group. The alkylene groups may be branched or linear. Preferred examples are —(CH₂)₁₋₂₀— groups, examples of which include —(CH₂)₂—, —(CH₂)₃—, —(CH₂)₄—, —(CH₂)₆— and —(CH₂)₈—.

A¹ and A² may also each independently be an optionally substituted xylylene group (—CH₂-phenylene-CH₂—). The CH₂ groups may be ortho, meta or para with respect to each other.

In view of the foregoing, preferably A¹ and A² are each independently selected from C₁₋₃₀ alkylene, phenylene, naphthylene and xylylene group, each of which may optionally be substituted. More preferably A¹ and A² are each independently selected from optionally substituted C₁₋₃₀ alkylene groups, preferred examples of which are mentioned above.

Preferred specific examples of A¹ and A² groups include *CH₂CH₂*, *CH₂CH*CH₃, *CH₂CH*CH₂CH₃ and ortho, para and meta-phenylene wherein the asterisk marks the point of attachment of the groups in the compound of Formula (1).

The groups A¹ and A² may be different but more preferably they are the same

The group Z may be any halogen without limitation. Preferred halogens include F, Cl, Br and I. Of these, Cl is especially preferred.

The compounds of Formula (1) are preferably prepared by a process comprising the reacting together compounds of the Formulae:

T¹A¹Q¹H

and

T²A²Q²H

with a trihalo triazine
wherein T¹, A¹, Q¹ and T², A² and Q² are as hereinbefore described and preferred.

Of course, in some cases T¹A¹Q¹H and T²A²Q²H may be identical to each other to give a symmetrical compound of Formula (1).

As mentioned above, T¹ and T² are preferably both —OH. Thus, in a preferred process for preparing compounds of the Formula (1), T¹A¹Q¹H and T²A²Q²H are both monoamino-monoalcohols.

Especially preferred examples of compounds of the formula T¹A¹Q¹H or T²A²Q²H include ethanolamine (HO—CH₂CH₂—NH₂), CH₃CH(OH)CH₂NH₂, CH₃CH₂CH(OH)CH₂NH₂, HO-phenylene-NH₂ and HOCH₂-phenylene-CH₂—NH₂. Other suitable examples of compounds of the formula T¹A¹Q¹H or T²A²Q²H include 3-amino propanol, 4-amino butanol, 2-amino-2-methyl-1-propanol, 5-amino pentanol, 6-amino hexanol and 8-amino octanol.

The corresponding monoamino-monothiols may also be used in place of one or both of the compounds of the formula T¹A¹Q¹H or T²A²Q²H.

The halo groups in the halo-triazine may be I, Br, Cl or F, but are preferably chlorine. Thus the preferred trihalo triazine is cyanuric chloride.

The process for preparing the compound of Formula (1) is preferably performed at a moderate to low temperature. For example, one may suspend the trihalo triazine in a liquid medium at a temperature of less than 10° C., preferably from −5° C. to 5° C., then mix the trihalo triazine with the compound(s) of Formulae T¹A¹Q¹H and T²A²Q²H and then heat the mixture, e.g. to a temperature in the range 30 to 50° C., more preferably 40 to 45° C.

Preferably the temperature in the range 30 to 50° C. (more preferably 40 to 45° C.) is maintained for a period of 1 to 10 hours, more preferably 2 to 4 hours and especially about 3 hours.

The process is preferably performed at a pH of from 5 to 9, more preferably from 6 to 7. Any suitable base may be used to obtain this pH. Preferred bases are alkali metal hydroxides, especially sodium hydroxide.

Preferably, the process further comprises the step of raising the temperature of the mixture to 50 to 80° C., more preferably to 50 to 70° C. and especially to around 60° C. Such temperatures are preferably maintained for a period of 1 to 5, more preferably from 1 to 3 hours and especially about 2 hours.

Preferably, the relative molar amounts of T¹A¹Q¹H and T²A²Q²H and trihalo-triazine correspond approximately to the theoretical structure, i.e. 1:1:1 (e.g. 1 mole:1 mole:1 mole).

The reaction is preferably carried out in a liquid medium, preferably an aqueous medium, especially water. Organic liquids may also be used, alone or in combination with water. Suitable examples of organic liquids include N-methyl pyrrolidone and sulfolane.

The above process may used to prepare a single compound of Formula (1) or a composition comprising number of different compounds of Formula (1).

The compounds of Formula (1) arising from the process may be used to prepare the first polymer with or without being purified. The compound of Formula (1) may purified, if desired, by any suitable technique. For example, one may isolate the compounds of Formula (1) on a filter and wash it with a pure liquid vehicle. The compound of Formula (1) may also be purified by ultrafiltration, e.g. using a membrane purification process.

It is sometimes useful to isolate the compound of Formula (1) in a dry form. Preferred drying methods include vacuum drying, oven drying, spray drying and the like. If the isolated compound of Formula (1) is not totally dry then the amount of residual water can be determined and accounted for when the first polymer is prepared by incorporating additional diisocyanate (component ii)) in the process according to the first aspect of the present invention.

The diisocyanate used as component ii) in the first aspect of the present invention may be of any kind without any particular limitation. Preferably the diisocyanate is aliphatic, aromatic or both aliphatic and aromatic. Mixtures of diisocyanates may also be used as component ii). Preferably, the diisocyanate is free from ionic, amino, hydrazo (H₂NHN—), thiol and hydroxyl groups. We have found that diisocyanates free from such groups have a low tendency to cause unwanted gelation or polymer branching.

Preferred examples of suitable diisocyanates which may used as component ii) include ethylene diisocyanate, 1,6-hexamethylene diisocyanate, tetramethylxylene diisocyanate, 1,4-phenylene diisocyanate, 2,4-toluene diisocyanate, 2,6-toluene diisocyanate, 4,4′-diphenyl-methane diisocyanate and its hydrogenated derivative, 2,4′-diphenylmethane diisocyanate and its hydrogenated derivative, 1,5-naphthylene diisocyanate and isophorone diisocyanate. Of these isophorone diisocyanate is especially preferred.

It is possible, though not preferable, to prepare the pre-polymer by reacting components i), ii) and optionally iii) along with some isocyanates having three or more isocyanate groups and/or some isocyanates having just one isocyanate group. If such isocyanates are used they are preferably only present in minor proportions. More preferably, the only isocyanates used in the process according to the first aspect of the present invention are diisocyanates.

Preferably the pre-polymer described in the first aspect of the present invention is obtained or obtainable by a process comprising reacting together at least the components i), ii) and iii), i.e. preferably optional component iii) is present.

Of course, as used herein the term isocyanate-reactive compound in component iii) means isocyanate-reactive compounds other than those of Formula (1). Isocyanate-reactive compounds are compounds which are reactive with the isocyanate groups present in component ii).

Preferred examples of isocyanate-reactive compounds include compounds having hydroxyl, thiol, amino and hydrazo (H₂NNH—) groups (as isocyanate-reactive groups). Preferably, the isocyanate-reactive compound has only two groups which are reactive with the isocyanate groups present in component ii). In this way the isocyanate-reactive compounds of component iii), when present, assist in producing a linear pre-polymer, as opposed to branched or gelled polymers. Preferably the isocyanate-reactive groups are selected from hydroxyl, thiol, amino and hydrazo groups.

It is also preferred that the isocyanate-reactive compounds are free from ionic groups, e.g. free from carboxylic acid, sulfonic acid and phosphorus-containing acid groups. The absence of such ionic groups again helps to prevent the formation of gel whilst the polymer is being formed. The isocyanate-reactive compounds may be aliphatic, aromatic or have both aliphatic and aromatic groups.

Preferred examples of isocyanate-reactive compounds include diamines, diols and dithiols. Of these, diamines and especially diols are preferred.

Preferred diols include ethyleneglycol, 1,2- and 1,3-propyleneglycol, 1,2-, 1,3-, 1,4- and 2,3-butylene glycols, 1,6-hexanediol and neopentyl glycol, 1,8-octanediol, bis-phenol A, cyclohexane diol, diethylene glycol, triethylene glycol, tetraethylene glycol, polyethylene glycol, dipropylene glycol, polypropylene glycol, dibutyleneglycol and the like. Of these ethylene glycol is especially preferred.

Preferred diamines include ethylene diamine, 1,2- and 1,3-propane diamine, 1,4-butane diamine, 1,5-pentane diamine, 1,6-hexane diamine, isophorone diamine, cyclohexane diamine, piperazine, 4,4′-methylene bis(cyclohexyl amine) and polyoxyalkylene diamines, for example those sold under the Jeffamine™ trade name.

Preferred dihydrazo compounds which may be used as component iii) include hydrazine and adipic acid dihydrazide.

Component iii) may also comprise mixtures of two or more isocyanate-reactive compounds.

When the first polymer is free from poly(ethyleneoxy) and polyester groups, we have found that the optical density of prints obtained from pigment inks containing the first polymer is often superior to inks containing polymers which have such groups. Therefore it is preferred that the first polymer (and the second polymer) are free from poly(ethyleneoxy) and polyester groups.

One may obtain the first polymer free from poly(ethyleneoxy) and polyester groups by ensuring that al of the components used to prepare the first polymer are free from poly(ethyleneoxy) and polyester groups.

If desired component iii) optionally comprises isocyanate-reactive compounds having one or three or more isocyanate-reactive groups. Preferably, however, the content of such isocyanate-reactive compounds in component iii) having one or three or more isocyanate-reactive groups is low (e.g. <10 wt %, more preferably <5 wt % of component iii)) so as not to make the pre-polymer molecular weight too low or make the pre-polymer too branched or gelled. Preferably component iii) comprises only difunctional isocyanate-reactive compounds (e.g. diols, diamines, dithols etc), i.e. component iii) is preferably free from isocyanate-reactive compounds having one or three or more isocyanate-reactive groups.

Preferably, all of the components used to prepare of the first polymer are free from choromophores. More preferably none of the reaction steps used to prepare the first polymer is performed in the presence of a chromophore. Chromophores are highly coloured materials, e.g. dyes. In this way colourless first polymers may be prepared which contain no chromophore groups in their structure.

Preferably, components i), ii) and iii) are free from ionic groups.

The reaction between components i), ii) and optionally iii) is preferably performed in a liquid medium. Preferably, the liquid medium is a good solvent for all the components. Preferred liquid media for the reaction of components i), ii) and optionally iii) include 2-pyrrolidone, n-methyl pyrrolidone, sulfolane and mixtures comprising two or more thereof. The reaction temperature is preferably from 50 to 150° C., more preferably from 70 to 120° C. and especially from 80 to 110° C. The time for the reaction depends on the components used and whether a catalyst is present, but suitable reaction times are from 1 to 48 hours, more preferably from 2 to 24 hours, especially from 4 to 24 hours and most especially from 4 to 12 hours. Any suitable catalyst which is used in the preparation of polyurethanes may be used. Preferred examples of catalysts include tin salts and hindered amines.

Preferably, the pre-polymer is free from ionic groups.

In one embodiment the pre-polymer is free from or has a negligible amount of hydroxyl, amino and/or thiol groups.

In another embodiment, the pre-polymer has terminal —OH and/or amine groups.

Preferably the pre-polymer has a weight averaged molecular weight (“Mw”) of from 1,000 to 500,000, more preferably from 5,000 to 200,000 and especially from 5,000 to 100,000.

Where a low viscosity dispersion is desired, the pre-polymer preferably has a weight averaged molecular weight of no more than 75,000, more preferably no more than 60,000.

The molecular weight (Mw) is preferably measured by gel permeation chromatography (GPC). The molecular weight standards employed are preferably polyethylene glycol or more preferably polystyrene. The solvent used for GPC is preferably dimethyl formamide, tetrahydrofuran or acetone.

Preferably, the acid value of the pre-polymer is negligible or zero.

The compounds of component iv) are selected from organic amines, organic alcohols and organic thiols, provided that at least one of the organic compounds in component iv) has at least one ionic group. Preferably the organic amines, organic alcohols and organic thiols are selected from organic mono-amines, organic mono-alcohols and organic mono-thiols. The amine may be a primary or a secondary amine. The use of mono-functional amines, thiols and alcohols assists in providing the first polymer having a desirable linear structure.

Preferably, at least one of the compounds in component iv) is a compound of the Formula (2) or (3):

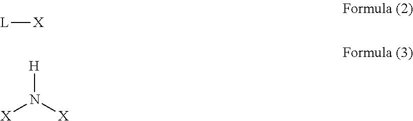

wherein:
L is H₂N—, HO— or HS—; and
each X independently is an optionally substituted organic group, provided that X in formula (2) and at least one of the X groups in Formula (3) has an ionic group.

In formula (3) the two X groups together with the N atom to which they are attached optionally form a cyclic structure carrying at least one ionic group. Examples of cyclic structures include C₅ and C₆ nitrogen containing heterocyclics (e.g. nitrogen containing heterocyclics containing 5 carbon atoms, e.g. pyridine and morpholine) carrying at least one ionic group.

More preferably all of the compounds in component iv) are of the Formula (2) or (3).

In the compounds of Formula (2) it is preferred that L is H₂N— or HO—, more preferably H₂N—. Such compounds have been found to be particularly effective at post functionalising the pre-polymer.

The optionally substituted organic group X in the compounds of Formula (2) and (3) may be of any kind without limitation. The organic group may be, for example, optionally substituted alkyl, aryl, heterocyclyl or combination of two or more thereof.

When an X group is optionally substituted alkyl, it is preferably optionally substituted C₁₋₂₀ alkyl.

When an X group is optionally substituted aryl it is preferably optionally substituted phenyl or naphthyl.

When an X group is optionally substituted heterocyclyl it may be aromatic (heteroaryl) or non-aromatic. When X is heterocyclyl it preferably comprises a 5- or 6-membered ring containing from 1 to 3 atoms selected from N, S and O in the ring and the remaining ring atoms are carbon atoms.

Preferred examples of optionally substituted heterocyclyl groups include optionally substituted pyrrolyl, thiophenyl, furanyl, pyridyl, pyrimidyl, pyrazinyl, triazinyl, imidazolyl, thiazolyl, oxazolyl and pyrazolyl.

The optional substituents may be any of those mentioned above for the R¹ and R² groups.

The ionic group present in at least one of the compounds of component iv) may be cationic or, more preferably, anionic.

Examples of cationic groups include quaternary amine, pyrridinium, guanidinium and biguanidinium groups. Suitable salt forms include the sulphate, nitrate, halide and carboxylate salts.

Preferred anionic groups include sulfonic acid, carboxylic acid and especially phosphorus-containing acid groups. Of these carboxylic acid and especially phosphorus-containing acid groups are preferred. Preferred examples of phosphorus-containing acids include phosphoric and especially phosphonic acid groups. In our studies we have found that the phosphorus-containing acid groups tend to promote particularly good optical density and good adherence and resistance properties to inks in which they are subsequently included.

The anionic groups may be in the form of the free acid or in the form of a salt or partial salt (e.g. partially neutralised). Preferably, during the preparation of the first polymer the anionic groups are in the free acid form. Salt forms include those with ammonium, organic ammonium, hydroxyl functional organic ammonium and especially alkali metal counter ions. Suitable alkali metals include potassium, sodium and lithium.

Preferably each X group has 1 to 3, more preferably 1 or 2 ionic groups.

Preferred examples of compounds of Formula (2) and (3) include aminomethylphosphonic acid, iminodi(methylphosphonic acid), N-methylaminomethylphosphonic acid, 2-aminoethylphosphonic acid, 3-aminopropylphosphonic acid, meta, ortho and para-aminophenylphosphonic acid, 4-aminobenzyl phosphonic acid, alendronic acid, pamidronic acid, neridronic acid, glyphosate, 2-amino-3-phospono propionic acid, 2-amino-4-phosophono butyric acid and the like and salts thereof. Of these aminomethylphosphonic acid and alendronic acid and salts thereof are preferred.

In some cases, some (but not all) of the compounds in component iv) are free from ionic groups. In this way the hydrophilicity of the final polymer can be tailored to ensure the first polymer matches a particular liquid vehicle, ink composition or particulate solid.

Preferably, the only reactant used to make the first polymer which has ionic groups is component iv). In other words, preferably components i), ii) and iii) are preferably free from ionic groups.

The total molar amount of compounds in component iv) can be varied widely. In one embodiment, one may use a number of moles of component iv) to which is substantially the same as the number of moles of remaining halo triazine (Z) groups in the pre-polymer. It is possible to use less than the required 1:1 stoichiometry to adjust the hydrophilicity of the first polymer. For example the compounds in component iv) may be added in a molar amount corresponding to less than 90 mole %, less than 80 mole %, less than 70 mole % or less than 50 mole % relative to the moles of Z (halo groups attached to triazine rings) groups in the pre-polymer. It is also possible to use a molar excess of the compounds in component iv), relative to the number of moles of remaining halo triazine (Z) groups in the pre-polymer.

The reaction between the pre-polymer and component iv) is preferably performed in a liquid medium. Preferred liquid media for this step include organic liquids, water and mixtures thereof. The temperature for the reaction between component iv) and the pre-polymer is preferably from 50 to 150, more preferably from 60 to 100 and especially from 70 to 90° C. The duration of the reaction varies widely but a suitable time is from 1 to 24 hours, especially from 5 to 16 hours and most especially from 6 to 14 hours. The reaction is preferably performed at a pH of from 7 to 12 and most preferably at a pH of from 9 to 12.

Depending on the reaction conditions and the stoichiometries of components used it is possible that the resulting first polymer has some remaining Z groups (halo groups attached to a triazine ring). These Z groups may be left as they are. In many cases it is preferable to hydrolyse the remaining Z groups to HO— groups. Preferably, the hydrolysis is performed in water using an acid or base to accelerate hydrolysis. Heating to an elevated temperature of between 60° C. to 90° C. is often used to accelerate the hydrolysis.

The polymer obtained from the process may be used to prepare the dispersion with or without having been purified. Preferably, however, the process further comprises the step of purifying the polymer, for example to remove some or substantially all impurities, e.g. unpolymerised compounds and any post functionalising residues. Suitable methods for purification include acid precipitation, washing and re-dissolving and membrane washing the polymer (especially ultrafiltration).

The first polymer preferably has from 0.1 to 10 mmoles, more preferably from 0.5 to 8 mmoles, even more preferably from 0.5 to 5 mmoles and especially from 1 to 3 mmoles of ionic groups per g of polymer. The preferred method of establishing the number of moles of ionic groups per g of polymer is by titrimetry, especially potentiometric titration.

The ionic groups of the first polymer are preferably anionic, more preferably the ionic groups are selected from carboxylic, sulfonic and phosphorus-containing acid groups. It is particularly preferred that the first polymer comprises phosphorus-containing acid groups, especially phosphonic acid groups.

Preferably the first polymer has an Mw of from 1,000 to 500,000, more preferably from 5,000 to 200,000 and especially from 5,000 to 100,000.

Preferably the first polymer has an Mw of no more than 75,000, especially no more than 60,000.

The Mw of the first polymer may be measured by the techniques described above for the pre-polymer. Preferably the Mw of the pre-polymer and the first polymer are measured by the same method.

Preferably the first polymer is soluble in water. More preferably the first polymer is soluble in water at 5% by weight when neutralised to 100% stoichiometry with lithium hydroxide for anionic groups or hydrochloric acid for cationic groups. Preferably the water-solubility of the first polymer is as measured at 25° C.

The first polymer may be branched but is preferably linear.

The first polymer preferably acts as a binder for the pigment.

Preferably the first polymer does not act as a dispersant for the pigment. Put another way, in a preferred embodiment the particulate solid is colloidally stable in the dispersion in the absence of the first polymer and in the presence of the first polymer.

Preferably the first polymer is not a cross-linked polymer.

The particulate solid may be of any kind without limitation. Preferably, however, the particulate solid is a colorant, especially a pigment. The pigment may comprise and preferably is an inorganic or organic pigment material or mixture thereof which is insoluble in the liquid vehicle. By insoluble we mean having a solubility of no more than 1 wt %, more preferably no more than 0.1 wt % by weight in the liquid vehicle. The solubility is preferably measured at a temperature of 25° C. The solubility is preferably measured at a pH of 8.

Preferably, the pigment has a solubility in deionized water at 25° C. of no more than 1 wt %, more preferably no more than 0.1 wt %.

A preferred pigment is an organic pigment, for example any of the classes of pigments described in the Third Edition of the Colour Index (1971) and subsequent revisions of, and supplements thereto, under the chapter headed “Pigments”. Examples of organic pigments include those from the azo (including disazo and condensed azo), thioindigo, indanthrone, isoindanthrone, anthanthrone, anthraquinone, isodibenzanthrone, triphendioxazine, quinacridone and phthalocyanine series, especially copper phthalocyanine and its nuclear halogenated derivatives, and also lakes of acid, basic and mordant dyes. Preferred organic pigments are phthalocyanines, especially copper phthalocyanine pigments, azo pigments, indanthrones, anthanthrones, and quinacridones.

Preferred inorganic pigments include carbon black (especially gas blacks), titanium dioxide, silicon dioxide, aluminium oxide, iron oxides and sulfides.

For ink jet printing, especially suitable pigments are carbon blacks, C.I. Pigment Red 122, C.I. Pigment Blue 15:3 and C.I. Pigment Yellow 74. Of course there are many alternative pigments the benefits of which are largely in the choice of the shade and colour characteristics etc.

The particulate solid in the dispersion preferably has a Z-averaged particle size of from 50 to 300 nm, more preferably from 70 to 200 nm and especially from 80 to 150 nm. The particle size is preferably measured by a light scattering device especially a Malvern Zetasizer™.

When the particulate solid is surface-modified with ionic groups these may be cationic or, more preferably, anionic. In surface-modified particulate solids the pigment (i.e. the pigment itself) is modified to carry ionic groups which are part of the pigment. This can be contrasted with particulate solids where the pigment itself is not itself modified, and does not have ionic groups, but instead the pigment is coated with a polymer (e.g. an ionic polymer) and the polymer has ionic groups.

Examples of surface-modified pigments having cationic groups include pigments having quaternary amine, pyridinium, guanidinium and/or biguanidinium groups.

Examples of surface-modified pigments having anionic groups include pigments having sulfonic acid, carboxylic acid and/or phosphorus-containing acid groups (e.g. phosphonic acid groups).

Surface-modified particulate solids can be prepared using a variety of chemistries known in the art. One popular route is to oxidize the surface of a particulate solid using oxidants such as air, ozone, hydrogen peroxide, hypochlorous acid, persulfates and nitrogen oxides. This route is especially suitable for carbon black pigments.

Surface-modified particulate solids can also be prepared by diazonium chemistry, azo chemistry and sulfonation. Of these the reaction of diazonium salts with particulate solids (especially pigments) is especially versatile. This process forms ionic groups on the surface of the particulate solid. Although, the ionic groups may be attached directly to the pigment or via a spacer, a spacer is commonly used. The most commonly employed spacer is the arylene ring and especially a phenylene ring. These rings may carry any of the above mentioned ionic groups.

Any means of chemical attachment can be used to form ionic groups on the pigment, but covalent bonding is especially preferred. Thus in a preferred embodiment the particulate solid comprises ionic groups and there is a covalent link joining the ionic groups to the pigment.

Surface-modified particulate solids and their preparation are described in many patents, including EP0904327 A1, EP1833932 B1, U.S. Pat. No. 3,347,632 and EP0894835 A2.

Surface-modified pigments are commercially available and can be purchased under the following trade names:

Cabojet™, including Cabojet™ 200, 300, 400, 250C, 450C, 260M, 265M, 465M, 470Y, 740Y, 480M, 352K, 480V, 740Y, 1027R, 554B sold by Cabot Corp. Bonjet™, including Bonjet™ CW1, CW2, CW3, CW4, CW5 and CW6.

When the dispersion comprises the one or more second polymer(s), the dispersion may contain a particulate solid which is surface-modified with ionic groups, although preferably the dispersion is free from particulate solids which are surface-modified with ionic groups. Thus when the dispersion comprises the one or more second polymer(s), it is preferred that all of the particulate solid (e.g. pigment) is not surface-modified with ionic groups and has situated on its surface one or more second polymers which is/are different from the first polymer.

In this case the particulate solid has one or more second polymers situated on its surface. The second polymer preferably acts as a dispersant for the particulate solid. The second polymer preferably provides the particles of the particulate solid with colloidal stability. Preferred second polymers are therefore dispersants.

The second polymer may be situated on the surface of the particulate solid by a variety of methods. The preferred methods comprise:
i) dispersion (especially comminution) of a mixture comprising the particulate solid, the second polymer(s) and a liquid vehicle; and
ii) in situ polymerisation of monomers in a dispersion comprising the particulate solid and a liquid vehicle;

When the liquid vehicle is aqueous, method i) may be carried out in several different ways, including iii) and iv) below:
iii) dispersion (especially comminution) of a mixture comprising the particulate solid, the second polymer(s) and a liquid vehicle which is or comprises water; and
iv):
a) dispersion of the particulate solid and the second polymer(s) into a water-miscible organic liquid; and then
b) dispersion of the product of a), into a liquid medium which is or comprises water;
c) optionally removing some or all of the water-miscible organic liquids.

As used herein iii) is the “direct” route and iv) is the “phase inversion” route.

Preferably the second polymer(s) is/are adsorbed onto the surface of the particulate solid or, more preferably, the second polymer(s) are cross-linked so as to encapsulate the particulate solid. The cross-linking preferably results in a dispersion of particles of the particulate solid encapsulated by a cross-linked shell of the second polymer(s). The cross-linking is preferably covalent crosslinking.

One may prepare particulate pigments having one or more polymers cross-linked on its surface (e.g. to form a cross-linked polymer shell) by, for example, the methods described in PCT patent publications WO2006/064193, WO2010/038071, WO2011/104526 and WO2011/141745. Alternatively, particulate pigments having one or more polymers cross-linked on their surface may be purchased from Fujifilm Imaging Colorants Limited, e.g. the APD1000 series of polymer-encapsulated particulate pigments.

A preferred method for preparing particulate pigments having one or more polymers cross-linked on their surface comprises:
i) dispersing (especially comminuting) of a mixture comprising the particulate solid, the second polymer(s) and a liquid vehicle; and then
ii) cross-linking the second polymer(s) so as to encapsulate the particles of the particulate solid in a cross-linked polymer shell.

Cross-linking can be self cross-linking wherein the second polymer comprises within its structure all the groups needed for cross-linking. Alternatively, the cross-linking can be achieved by means of the addition of a cross-linking agent.

Preferably the second polymer is a polytriazine which is free from urethane linkages, a polyamide, a polyurethane which is free from triazine linkages, a polyester, a polyvinyl polymer or a polymer comprising two or more thereof.

More preferably, the second polymer is a polyester, a polyurethane which is free from triazine linkages, a polyvinyl polymer or a combination thereof, more preferably a polyurethane with no triazine linkages, a polyvinyl polymer or a polymer comprising two or more thereof, especially a polyvinyl polymer.

Polyurethanes typically comprise urethane (also known as carbamate) linkages. Polyurethanes used in the present invention as the second polymer may also comprise other linkages in addition the urethane linkages, such as urea, thiocarbamate, allophanate, biuret and/or isocyanurate groups.

Polyurethanes used as the second polymer(s) are preferably free from triazine linkages in the main backbone structure. More preferably the polyurethanes used as the second polymer(s) are free from triazine groups. The most commonly practiced method of preparing polyurethanes is by the reaction between an isocyanate (especially a diisocyanate) and an alcohol (especially a diol).

Polyesters comprise ester linkages. Typically these are prepared by the reaction between an alcohol (especially diols) and an acid (especially diacids). In place of diacids, acid chlorides, acid anhydrides and methyl and ethyl esters of diols can be used.

Polyvinyl polymers may be obtained by the polymerisation of ethylenically unsaturated monomers. Such monomers include ethylenically unsaturated acrylates, styrenics and the like.

Suitable second polymers include those mentioned in PCT patent publication WO2006/064193 at page 4, line 29 to page 10, line 23, which are incorporated herein by reference thereto.

Preferred polyurethanes having no triazine linkages are as described in PCT patent publication WO2011/104526 at pages 4 to 13 under the heading polyurethane dispersant, which are incorporated herein by reference thereto. Especially suitable polyurethanes are those comprising the repeat units derived from isophorone diisocyanate and dimethylol propanoic acid.

Preferred vinyl polymers are as described in PCT patent publication WO2010/038071 from pages 4 to 10 under the heading dispersant, which are incorporated herein by reference thereto.

Especially suitable vinyl second polymers are those derived from polymerising ethylenically unsaturated acrylic and/or styrenic monomers. Suitable examples include the polymers sold under the Joncryl™ trade name, from BASF. As used herein the term acrylic is meant to include both acrylates and methacrylates.

Other vinyl polymers which may be used as the second polymer include styrene maleic anhydride copolymers, including the (partially) hydrolysed derivatives and amide esters thereof. Suitable examples include those sold by Cray Valley under the SMA™ trade name.

Polyamides may be prepared by the reaction of a diamine and a diacid chlorides and/or diacid anhydride.

Polytriazines having no urethane linkages are preferably prepared by the method described in PCT patent publications WO2011/141745 and WO2011/141744.

Second polymers preferably have graft, comb or star structures, more preferably a linear structure.

The second polymers which may be used in the present invention may be prepared synthetically or they may be obtained from commercial sources.

Two or more second polymers may be used.

The second polymers preferably have ionic and especially anionic groups, for example the ionic groups as mentioned and preferred in relation to the first polymer. As with the first polymer the anionic groups in the second polymer may be in the form of the free acid, a partial or complete salt. Suitable bases for forming the partial and complete salts are as mentioned above for the first polymer.

Preferred second polymers have carboxylic acid groups.

Preferably the second polymer(s) have acid values of from 50 to 300, more preferably from 60 to 200 and especially from 70 to 180 mg KOH/g.

Preferably, the second polymer(s) are present at from 10 to 200%, more preferably from 20 to 150%, especially from 20 to 100% and more especially from 20 to 60% by weight relative to the amount of particulate solid present in the dispersion.

Preferably the second polymer(s) are not ethoxylated acetylenic diols. Preferably the second polymer(s) are not acetylenic diols. Preferably the second polymer(s) are free from acetylenic groups.

The dispersion may be in any form, for example in the form of a fluid wet paste, mill-base, concentrate, ink or tint.

In order of increasing preference, the dispersion preferably comprises at least 0.1, 0.5, 1, 2, 3, 5, 7, 9 and 10 wt % of the first polymer. One advantage of the present invention is that the first polymer can be used at these levels whilst substantially retaining good printing (especially ink jet printing) performance and operability. Also the dispersion typically has a lower viscosity than might be expected for the amount of polymer incorporated in the dispersion.

In order of increasing preference the dispersion preferably comprises no more than 50, 40, 30, 20 wt % of the first polymer.

Preferred dispersions comprise from 0.1 to 20 wt % of the first polymer.

In order of increasing preference the dispersion preferably comprises at least 0.1, 0.5, 1, 3, 5, 10, 15 and 20 wt % of particulate solid.

In order of increasing preference the dispersion preferably comprises no more than 50, 40, 35 and 30 wt % of particulate solid.

In order of increasing preference the dispersion preferably comprises at least 0.1, 0.25, 0.5, 0.75, 1, 2, 3, 5, 7, 10, 15, 20, 25, 30% of second polymer(s).

In order of increasing preference the dispersion preferably comprises no more than 60, 55, 50, 45 and 40 wt % of second polymer(s).

Preferably the weight ratio of the first polymer to the second polymer is from 1:20 to 20:1, more preferably from 1:10 to 10:1, especially from 7:1 to 1:7, more especially from 7:1 to 1:3 and most especially from 5:1 to 1:2. We have found that these ratios can provide inks containing the dispersions with an especially good combination of optical density, adhesiveness and wet fastness resistance.

Preferably the dispersion comprises:

i) 0.1 to 50 parts, more preferably 0.1 to 20 parts, of the first polymer;
ii) 0.1 to 30 parts, more preferably 1 to 30 parts, of the particulate solid;
iii) 0.1 to 40 parts, more preferably 0.5 to 40 parts, of the second polymer;
iv) 50 to 99.7, more preferably 60 to 98.4, parts of the liquid vehicle;
wherein the sum of the parts i) to iv) is 100 parts and all parts are by weight.

Preferably the first polymer is substantially separate from the particulate solid particles. Preferably the first polymer is (substantially) not adsorbed onto the surface of the particulate solid.

Preferably at least 0.1 wt %, more preferably at least 0.25 wt %, especially at least 0.5 wt % and more especially at least 1 wt % of the first polymer relative to the weight of the dispersion (or ink when present in an ink) is present freely in the liquid vehicle and is not associated with the particulate solid.

In some cases, the first polymer may be present in the dispersion (or ink) as polymer particles which are free from the particulate solid. For example, the first polymer may be dissolved in the liquid vehicle.

When the first polymer is soluble in the liquid vehicle the measurement of the amount of free first polymer is preferably done by means of ultracentrifugation of a sample of the dispersion, removal of the supernatant and then gravimetric analysis of the amount of first polymer in the supernatant after complete drying.

The total amount of second polymer(s) in the dispersion (or ink) is preferably from 1 to 150%, more preferably from 1 to 40%, especially from 1 to 30% and more especially from 3 to 20% by weight based on the weight of particulate solid.

A preferred method for preparing the dispersions according to the first aspect of the present invention is to disperse, especially to comminute, a composition comprising the second polymer(s), the particulate solid and the liquid vehicle. Dispersion processes include stirring, blending, shaking as well as milling, microfluidizing and ultrasonication etc.

Comminution typically significantly reduces the particle size of the particulate solid. Comminution includes, for example, ultrasonication, bead milling, microfluidizing and high pressure homogenising. Comminution does not include low shear dispersion processes such as stirring, shaking, tumbling or the like. Preferably, no first polymers are present whilst the particulate solid, second polymer(s) (when present) and liquid vehicle are being dispersed or comminuted. This helps to ensure that the second polymers act as dispersants and the first polymers act as binders. Preferably, the second polymer(s) are the only polymers present during the dispersion or comminution step.

The liquid vehicle may be wholly organic, although preferably the liquid vehicle is or comprises water (i.e. the liquid vehicle is preferably aqueous).

In some cases, the liquid vehicle comprises water and optionally one or more water-miscible organic liquids. In some instances it is preferred that the liquid vehicle comprises water and less than 30% by weight, more preferably less than 20% by weight and especially less than 10% by weight of water-miscible organic liquids relative to the total amount of liquids present in the dispersion. In some cases the liquid vehicle for the dispersion comprises of water and is free from organic liquids. These dispersions facilitate more formulation options and can be used as ink pre-cursors.

Preferred water-miscible organic liquids for inclusion into the liquid vehicle include one or more of the following:
i) C₁₋₆-alkanols, preferably methanol, ethanol, n-propanol, isopropanol, n-butanol, sec-butanol, tert-butanol, n-pentanol, cyclopentanol and cyclohexanol;
ii) linear amides, preferably dimethylformamide or dimethylacetamide;
iii) water-miscible ethers, preferably tetrahydrofuran and dioxane;
iv) diols, preferably diols having from 2 to 12 carbon atoms, for example ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol;
v) triols, preferably glycerol and 1,2,6-hexanetriol;
vi)mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy) ethoxy]ethanol, 2-[2-(2-ethoxyethoxy)-ethoxy]-ethanol and ethyleneglycol monoallylether;
vii) cyclic amides, preferably 2-pyrrolidone, N-methyl-2-pyrrolidone, N-ethyl-2-pyrrolidone, caprolactam and 1,3-dimethylimidazolidone.

Preferably, the liquid vehicle comprises water and optionally 1 or more, especially optionally from 1 to 3, water-miscible organic liquids.

Preferably, in inks the particulate solid in the dispersion according to the first aspect of the present invention is a pigment. Preferably, no other colorant is present in the ink.

Preferably, the ink (especially an ink jet printing ink) comprises a dispersion according to the first aspect of the present invention.

According to a second aspect of the present invention there is provided an ink comprising a dispersion according to the first aspect of the present invention.

In order for the ink to be coloured, it is preferred that the particulate solid present in the ink according to the second aspect of the present invention is a pigment.

Preferably the ink is an ink jet printing ink.

Preferably the ink has a viscosity of less than 30 mPa·s, more preferably less than 20 mPa·s and especially less than 10 mPa·s. The viscosity is preferably at least 2 mPa·s. Preferably the viscosity is Newtonian. Preferably the viscosity is measured at 25° C. Preferably the viscosity is measured using a shear rate of 100 s⁻¹. The viscosity is preferably measured using a cone and plate geometry. A preferred apparatus for measuring the viscosity is a TA Instruments rheometer.

Preferably the ink comprises:
i) 0.1 to 10 parts, more preferably from 0.5 to 10 parts, especially from 1 to 7 parts, of the first polymer;
ii) 0.1 to 10 parts, more preferably from 1 to 10 parts, of a pigment as particulate solid;
iii) 0.1 to 10 parts, more preferably from 1 to 10 parts, of the second polymer;
iv) 70 to 99.7 parts, more preferably 70 to 97 parts, of the liquid vehicle;
   wherein all parts are by weight. Preferably, the sum of the parts i) to iv) is 100.

Preferably the ink has a surface tension of 20 to 65 dynes/cm, more preferably 30 to 60 dynes/cm, when measured at a temperature of 25° C. The surface tension is preferably measured using a Kibron AquaPi apparatus.

The pH of the ink is preferably from 4 to 11, more preferably from 7 to 10.

When the ink is to be used as an ink jet printing ink, the ink preferably has a concentration of halide ions of less than 500 parts per million, more preferably less than 100 parts per million. It is especially preferred that the ink has less than 100, more preferably less than 50 parts per million of divalent and trivalent metals. Parts per million as used above refers to parts by weight relative to the total weight of the ink. These low concentrations of ions in the resultant ink can be achieved by, for example, purifying the ink or its components using membrane techniques such as reverse osmosis, distillation and/or ultrafiltration.

Preferably the ink is substantially free from particles having a particle size (e.g. diameter) of greater than 1 micron. The ink may be treated to remove such particles by, for example, centrifugation or filtration.

The ink preferably comprises a liquid vehicle which is or comprises water. More preferably the liquid vehicle further comprises at least one water-miscible organic liquid. Preferably, the weight ratio of water to water-miscible organic liquid when both are present in the liquid vehicle may be from 99:1 to 5:95, more preferably 95:5 to 50:50, especially 95:5 to 70:30. Preferred water-miscible organic liquids are mentioned above. These inks are especially useful for ink jet printing as they assist in preventing any polymer from depositing on the ink jet printer nozzles. These water miscible organic liquids also help in the firing, substrate wetting, surface tension and substrate penetration characteristics of the ink.

The ink may optionally contain one of more ink additives. Preferably, the ink further comprises one or more additives selected from viscosity modifiers, pH buffers, metal chelating agents, surfactants, corrosion inhibitors, biocides, dyes, water miscible organic solvent(s) and/or kogation reducing additives. Preferably, all of these additives amount to no more than 10 parts, more preferably no more than 7 parts and especially no more than 5 parts by weight relative to the above ink components.

The inks of the present invention are especially useful for ink jet printing because they have a low tendency to suffer from polymer depositing on the ink jet printer nozzles in what is sometimes called a “seeping out” phenomina. The water-miscible organic liquids also help in the firing, substrate wetting, surface tension and substrate penetration characteristics of the ink.

The inks may optionally contain one of more further ink additives, e.g. viscosity modifiers, pH buffers, metal chelating agents, surfactants, corrosion inhibitors, biocides, dyes and/or kogation reducing additives.

According to a third aspect of the present invention there is provided an ink jet printer cartridge comprising a chamber and an ink, wherein the ink is present in the chamber and the ink is as defined in the second aspect of the present invention.

According to a fourth aspect of the present invention there is provided a substrate printed with an ink according to the second aspect of the present invention. The substrate may be of any kind including paper, glass, metal, fabric and plastic. The present inventors have found that the inks according to the second aspect of the present invention can be used to provide prints having especially good optical density, even when printed on plain paper. The prints also demonstrate particularly good wet and dry rub-fastness. The present inventors found that the performance of the inks on the substrate was less sensitive to the kind of substrate than inks containing binders they had previously tested.

The dispersions and inks according to the first and second aspects of the present invention may be prepared by several routes.

According to a fifth aspect of the present invention there is provided a process for preparing a dispersion according to the first aspect of the present invention or an ink according to the second aspect of the present invention comprising combining the components a) and b):

wherein component a) is a first polymerobtained or obtainable by the process steps i), ii) optionally iii), and iv) described above in relation to the first aspect of the present invention; and component b) is a dispersion comprising a particulate solid and a liquid vehicle, wherein the particulate solid is surface-modified with ionic groups and/or the particulate solid has situated on its surface one or more second polymers which is/are different from the first polymer.

Components a) and b) may be combined by a process comprising rolling, stirring, homogenising, ultrasonication, high speed shear mixing and/or microfluidizing components a) and b).

Preferably the combination of components a) and b) is performed under low shear conditions. Examples of such low shear conditions include rolling, stirring, tumbling and/or shaking of a mixture comprising the components a) and b).

In the case where the particulate solid has situated on its surface one or more second polymers, it is preferred that the particulate solid is dispersed, more preferably comminuted in a composition comprising the liquid vehicle and the second polymer(s). Preferably, (as mentioned above) the first polymers are absent during the comminution step. Preferred means for comminution are as mentioned before.

When the second polymer(s) are cross-linked so as to encapsulate the particulate solid particles with a cross-linked second polymer shell, it is preferred that the cross-linking reaction is carried out prior to the combination of components a) and b). In this way there is little or no chance that the first polymer can be cross-linked onto the surface of the particulate solid. The cross-linking may be effected by the use of self cross-linkable second polymer(s) or, more preferably, the second polymer(s) may be cross-linked by the addition of a cross-linking agent. The preferred cross-linking agents are epoxy cross-linking agents, e.g. crosslinking agents comprising two or more epoxy groups.

### EXAMPLES

The present invention will now be illustrated by the following examples in which all parts are by weight unless stated to the contrary.

### 1. Preparation of Polymer Solution (1)

### 1.1 Preparation of the Compound of Formula (1a)

In step 1.1 the following compound of Formula (1a) was prepared.

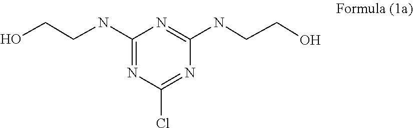 [SMILES: OCCNc1nc(Cl)nc(NCCO)n1]

Cyanuric chloride (0.50 mol, 92.2 g) was suspended in water (300 ml) and cooled to a temperature of from 0 to 5° C. in a reactor. A solution of ethanolamine (1.0 mol, 61.3 g) in water (50 ml) was added dropwise to the reactor contents whilst maintaining the temperature at 0 to 5° C. to form a reaction mixture.

On completion of the addition, the reaction mixture was warmed to a temperature of 40 to 45° C. and stirred at this temperature for 3 hours whilst slowly adding a solution of sodium hydroxide (1.0 mol, 40 g) in water (100 ml) to maintain the pH at 6-7.

The reaction mixture was then stirred at a temperature of 60° C. for 2 hours and then allowed to cool to a temperature of 25° C.

The resulting product was collected by filtration, washed with pure water (5×100 ml) and dried in a vacuum oven at 50° C. to give 115 g of a white solid. The resulting dry product was dissolved in N methyl pyrrolidone (460 g) and stored over 4A molecular sieves to give a 20% by weight solution of the compound of Formula (1a). This was designated Monomer Solution (1).

### 1.2 Preparation of Pre-Polymer Solution (1)

A mixture of the Monomer Solution (1) prepared in step 1.1 (0.200 mol, 116.85 g), ethylene glycol (0.406 mol, 12.59 g), isophorone diisocyanate (0.576 mol, 64.04 g) and N-methyl pyrrolidone (6.52 g) were stirred and heated to a temperature of 50° C. and 2 drops of tin ethylhexanoate were added. This formed a reaction mixture. The reaction mixture was stirred at a temperature of 95 to 100° C. for a period of 18 hours. N-methyl pyrollidone (200 g) was added to the reaction mixture which was allowed to cool to a temperature of 25° C. to give a 25% by weight solution of the desired pre-polymer in N-methyl pyrrolidone. This was designated Pre-polymer Solution (1).

Pre-polymer (1) had a number average molecular weight of 23,345 and a weight average molecular weight of 39,115 as measured by GPC using polystyrene standards and dimethyl formamide solvent.

### 1.3 Preparation of Polymer Solution (1)

A mixture of the Pre-polymer Solution (1) prepared in step 1.2 (100 g) and aminomethanephosphonic acid (5.7 g) was stirred and heated at a temperature of 80° C. to form a reaction mixture. A solution of tetrabutylammonium hydroxide (26 g) in water (40 ml) was added to the reaction mixture which was subsequently stirred and heated at a temperature of 80° C. for 10 hours. The reaction mixture was cooled to a temperature of 25° C., added to water (2000 ml) to give a solution and then acidified by the addition of concentrated hydrochloric acid until the pH was reduced to 0.5. The resultant precipitate was collected by filtration and then suspended in water (2000 ml). The pH of the suspension was adjusted to 11 by the addition of lithium hydroxide and then the suspension was stirred for 1 hour. Following acidification as described above the precipitate was collected, suspended in water (500 ml) at pH=11 (LiOH) and dialysed to a low conductivity (<100 μS cm⁻¹). The dialysed solution was concentrated under reduced pressure to give 200 g of a yellow solution which contained the desired Polymer (1) at a concentration of 8.7% by weight. This was designated as Polymer Solution (1).

Phosphorus elemental analysis of a dried sample of Polymer Solution (1) indicated a content of 2.8% wt/wt of phosphorus relative to the polymer. This equates to an acid value of 1.8 mmol/g.

### 2 Preparation of Comparative Polyurethane Binder Dispersion (1)

### 2.1 Stage 1—Preparation of a Comparative Polyurethane Prepolymer (1)

A one litre round-bottomed reactor was fitted with a mechanical paddle stirrer, a thermocouple and a water-cooled condenser. The following steps were performed under a nitrogen blanket.

Polypropylene glycol 1000 (215.34 g), dimethylol propionic acid (90 g) and tetramethylene sulfone (323.08 g) were charged to the reactor at 19-22° C., followed by isophorone diisocyanate (294.66 g), which was added with stirring. The reaction mixture was then warmed to 95° C. over about 10 minutes using an external isomantle.

At 95° C. an exotherm was observed and this was controlled using an external ice bath. The reactor was then maintained at 95° C. for a further two hours after which a sample was removed for isocyanate determination. The isocyanate determination was performed by a titration method to check for complete reaction by comparing the theoretical with the experimental isocyanate value (experimental value 3.8% and theoretical value 4.00%). This prepared Comparative Polyurethane Prepolymer (1).

### 2.2 Stage 2—Preparation of Partially End-Capped Comparative Polyurethane Prepolymer (1)

Tri(propylene glycol) mono methyl ether (an end-capping agent) (12.86 g) was added to the reactor mentioned in step 2.1, stage 1, through a pressure equalizing dropping funnel. The reactor was then maintained at 95° C. for a further 60 minutes whilst still under a nitrogen blanket. A sample was extracted for isocyanate determination using a titration method. The extent of end-capping was 7.5%. This prepared the partially end-capped Comparative Polyurethane Prepolymer (1).

### 2.3 Stage 3—Preparation of Comparative Polyurethane Binder Dispersion (1)

Ethylene diamine (9.64 g), aqueous potassium hydroxide 10% w/w (384.94 g) and deionized water (1481.24 g) were added to a 10 litre baffled round-bottomed reactor to form a mixture. The mixture was warmed to a temperature of 25° C.

Partially end-capped Comparative Polyurethane Prepolymer (1) arising from stage 2, point 2.2, (871.3 g) was cooled to 75-80° C. and then dispersed into the above mixture using agitation.

Agitation was maintained throughout the dispersion process and for several hours afterwards. The temperature during the dispersion of the partially end-capped polyurethane prepolymer was kept below 40° C. by the use of an external ice bath. After ensuring that the pH was in the range 8 to 9, the product was filtered through a 52 micron cloth to give the desired Comparative Polyurethane Binder Dispersion (1) having a pH of 8.32, a solids content of 22.05%

The comparative polyurethane binder in the dispersion comprised the residues of dimethylol propionic acid (14.44%), poly propylene glycol 1000 (34.55%), isophorone diisocyanate (47.28%), tri(propylene glycol) mono methyl ether (2.07%) and ethylene diamine (1.66%). The Comparative Polyurethane Binder (1) contained no triazine linkages.

The comparative polyurethane binder had a number averaged molecular weight of 36,600 and a weight averaged molecular weight of 36,600 as determined by GPC.

### 3. Preparation of Inks

Comparative Inks 1 and 2 and Ink 1 of the present invention were prepared by mixing together the components and amounts as described in Table 1. In Table 1 all the parts are by weight. In Table 1 all the amounts relate to the neat (dry solids) materials. Thus as an example, 6 parts of CAB-O-JET™ is provided by 60 parts of a dispersion which has a pigment content of 10 wt % in the dispersion. Similarly, 1 part of Polymer (1) is obtained from 100/8.7 wt % (=11.49 parts) parts of Polymer Solution (1) as obtained in point 1.3 above. Also, 1 part of Comparative Polyurethane Binder (1) is obtained from 100/22.05 wt % (=4.54 parts) of the Comparative Polyurethane Binder Dispersion (1) in point 2.3 above

TABLE 1

| | Comparative | | Comparative |
|---|---|---|---|
| Component | Ink 1 | Ink 1 | Ink 2 |
| CAB-O-JET ™ 300 | 6 | 6 | 6 |
| 2-Pyrrolidone | 3 | 3 | 3 |
| Glycerol | 15 | 15 | 15 |
| 1,2 Hexane diol | 4 | 4 | 4 |
| Ethylene glycol | 5 | 5 | 5 |
| Surfynol ™ 465 | 0.5 | 0.5 | 0.5 |
| Polymer (1) | 0 | 1 | 0 |
| Comparative | 0 | 0 | 1 |
| Polyurethane | | | |
| binder (1) | | | |
| Pure water | To make | To make | To make |
| | 100 parts | 100 parts | 100 parts |

Surfynol^{R} ™ 465 is a surfactant available from Airproducts.
CAB-O-JET ™ is a surface-modified carbon black available from Cabot Corp.

### 4. Preparation of Prints

Each of the Inks described above were printed onto both a plain paper, namely HP all in one printing paper Colorlok™ and onto a coated photo paper, namely Seiko Epson Corp Crispia™ photo MkII. Printing was performed by means of an Epson SX218 ink jet printer. The printer printed 100% blocks of black ink.

### 5. Measurements

### 5.1 Reflectance Optical Density (ROD)

For each print the ROD was measured using a Gretag Macbeth key wizard V2.5 Spectrolino photodensitometer instrument, illuminated using a D65 light source at an observer angle of 2° and with no filter fitted. Measurements were taken at least two points along the print and were then averaged.

### 5.2 Highlighter Smear Resistance

Highlighter smear resistance was tested by highlighting twice across the same part of a block of print on the HP all in one Colorlok™ printing paper. The highlighter passes were started approximately 1 cm to into the block on printed paper and continued across the width of the block before finishing approximately 1 cm into the unprinted region. Both highlighter passes followed the same path 1 cm over the block of print and 1 cm into the unprinted region. A Sharpie accent highlighter pen was used throughout.

Any pigment which moved from the printed region into the unprinted region gave rise to a darkened or smeared appearance visible in the unprinted region.

The amount of highlighter smear resistance was quantified visually in the unprinted region wherein:

0=extensive smearing

1=significant smearing

2=slight smearing

3=no smearing

So a higher scope is better.

### 5.3 Adhesion to the Substrate

This measurement was performed on block prints on Seiko Epson Corp Crispia™ photo MKII paper. The block of black print was rubbed twice with a back of a finger nail. If any pigment is removed from the printed block the white paper underneath becomes visible.

The amount of adhesion was then quantified visually:

0=All pigment removed from tested area, clear white line obtained

1=Significant removal of pigment

2=slight removal of pigment

3=No pigment removed

So a higher scope is better.

### 6. Results

The results of the measurements are summarised below in Table 2.

TABLE 2
Summary of results

| | ROD on HP | | Highlighter | |
|---|---|---|---|---|
| | all in one | ROD on | durability on | |
| | printing | SEC | HP all in one | Adhesion on |
| | paper | Crispia ™ | printing paper | Crispia ™ |
| Ink | Colorlok ™ | photo MkII | Colorlok ™ | photo MkII |
| Comparative | 1.34 | 1.84 | 0 | 0 |
| Ink (1) | | | | |
| Ink (1) | 1.39 | 1.96 | 1 | 3 |
| Comparative | 1.29 | 1.86 | 3 | 0 |
| Ink (2) | | | | |

As can be seen from Table 2, Ink (1) from the present invention provided superior optical density (ROD) than the Comparative Examples on both kinds of paper. Furthermore, Ink (1) from the present invention provided superior adhesion to Crispia™ photo MkII paper and improved highlighter durability on HP all in one printing paper Colorlok™ compared to Comparative Ink (1).

Comparative Ink (2) contained the comparative polyurethane binder as disclosed in WO2009/115831 at page 22, line 23. These results show how the first polymers used in the present invention are markedly technically superior as binders to what was known in the art.

7. Further inks

The further inks described in Tables I and II may be prepared.

In Tables I and II Dispersion 1 refers to a 10 wt % dispersion of CAB-O-JET™ 300 in water and Dispersion 2 refers to a 10 wt % dispersion of Pro-Jet™ Black ADP1000 in water available from FUJIFILM Imaging Colorants Ltd. In all cases the amounts are in parts by weight.

The inks may be applied to paper by thermal, piezo or Memjet ink jet printing.

The following abbreviations are used in Tables I and II:

PG=propylene glycol

DEG=diethylene glycol

NMP=N-methyl pyrrolidone

DMK=dimethylketone

IPA=isopropanol

MEOH=methanol

2P=2-pyrrolidone

MIBK=methylisobutyl ketone

P12=propane-1,2-diol

BDL=butane-2,3-diol

Surf=Surfynol™ 465 from Air Products

PHO=Na₂HPO₄ and

TBT=tertiary butanol

TDG=thiodiglycol

GLY=Glycerol

nBDPG=mono-n-butyl ether of dipropylene glycol

nBDEG=mono-n-butyl ether of diethylene glycol

nBTEG=mono-n-butyl ether of triethylene glycol

TABLE I

| | Mill-base | | | | | | | | | | | | | |
|---|---|---|---|---|---|---|---|---|---|---|---|---|---|---|
| Dispersion | Content | Water | Polymer 1 | DEG | NMP | DMK | NaOH | Na Stearate | IPA | MEOH | 2P | MIBK | GLY | nBDPG |
| 1 | 30 | 50 | 5 | | 6 | 3 | | | | | 5 | | 1 | |
| 1 | 30 | 59.8 | 0.2 | 4.8 | 5 | | 0.2 | | | | | | | |
| 1 | 40 | 45 | 3 | | 3 | 3 | | | | 5 | 1 | | | |
| 1 | 40 | 51 | 0.1 | 8 | | | | | | | | 0.9 | | |
| 1 | 40 | 45.8 | 5 | | | | | 0.2 | 4 | | | 5 | | |
| 1 | 40 | 41 | 1 | | 9 | | 0.5 | 0.5 | | | 8 | | | |
| 1 | 40 | 10 | 4 | 13 | 3 | 3 | | | 6 | 10 | 5 | 4 | | |
| 1 | 40 | 30 | 2 | 20 | | | | | 7 | | | | | 1 |
| 1 | 50 | 25 | 5 | 5 | | 5 | | | | 6 | | 5 | | |
| 1 | 50 | 29.7 | 3 | | 2 | 10 | | 0.3 | | | | | | |
| 2 | 50 | 15 | 0.7 | 4.3 | 4 | 6 | | | 5 | 4 | 6 | 5 | | |
| 2 | 50 | 44.2 | 1.8 | | | | | | | 4 | | | | |
| 2 | 40 | 6 | 5 | | | | | | 5 | | | | | |
| 2 | 40 | 50 | 2 | 6 | 2 | 5 | | | 1 | | 4 | | | |
| 2 | 40 | 37.6 | 2.4 | 5 | | | | | | | 15 | | | |
| 2 | 40 | 36.9 | 3.1 | | 11 | | | | | | 5 | | | |
| 2 | 50 | 44 | 2 | | | 10 | | | | 2 | | 6 | | |
| 2 | 50 | 28.1 | 1.9 | | | 7 | 0.3 | | 3 | | | | | |
| 2 | 40 | 29 | 2 | 20 | 2 | 1 | | | | | 3 | 3 | | |
| 2 | 40 | 38.7 | 1 | | 4 | | | | | | 5 | | | |
| 2 | 40 | 29 | 2 | | | | | | | | | | 20 | |
| 2 | 40 | | 2 | | | | | | | | | | | 18 |

TABLE II

| | Mill-base | | | | | | | | | | | | | |
|---|---|---|---|---|---|---|---|---|---|---|---|---|---|---|
| Dispersion | content | Water | Polymer 1 | DEG | NMP | Surf | TBT | TDG | BDL | PHO | 2P | PI2 | nBDEG | nBTEG |
| 1 | 30 | 63.3 | 1.5 | | | 0.2 | | | | | 5 | | | |
| 1 | 30 | 58.8 | 1 | 4 | | | | | | 1.2 | | 5 | | |
| 1 | 40 | 44.6 | 5 | 5 | | 0.1 | 4 | 0.2 | | | | | | 1 |
| 1 | 40 | 5 | 2 | 4 | 4 | 5 | | | | 0.12 | | | | |
| 1 | 40 | 49.8 | 4 | 8 | | | | | | | | 6 | | |
| 1 | 40 | 8 | 1 | 10 | | 0.3 | | | 4 | 0.2 | | | | |
| 1 | 50 | 41.7 | 1 | 4 | 5 | | | 0.3 | | | | | | |
| 1 | 50 | 44.8 | 3 | 10 | 1 | | | | 1 | | 4 | 11 | | |
| 1 | 40 | 39.7 | 4 | 10 | 3 | | | | 2 | | 6 | | | |
| 1 | 40 | 20 | 4 | | 2 | | | | | | 3 | | | |
| 2 | 40 | 35 | 3 | 6 | 7 | | 2 | | | 0.95 | 5 | | 1 | |
| 2 | 40 | 51 | 5 | 11 | | | | | | | 6 | | | |
| 2 | 50 | 35.0 | 2 | | 5 | | | | | | 7 | | | |
| 2 | 50 | 5 | 5 | 5 | 4.1 | | 0.2 | 0.1 | 5 | 0.1 | 5 | | | |
| 2 | 40 | 35 | 3 | 10 | | 1 | | | | | | | | |
| 2 | 40 | 34 | 2 | | | | | 10 | | | | | | |
| 2 | 30 | 23.5 | 1 | | 5 | | | 12 | | | 5 | | | |
| 2 | 30 | 50 | 2 | | 8 | | | 15 | | | 5 | | | |
| 2 | 40 | 49 | 1 | | | | | 8 | | | 12 | | | |
| 2 | 40 | 47 | 1 | 10 | | | | | | | | | 10 | |
| 2 | 40 | 39 | 1 | | | | | | | | 10 | | | 10 |

1. A dispersion comprising a particulate solid, a liquid vehicle and a first polymer, wherein:
the first polymer is obtained or obtainable by a process comprising reacting at least the components i), ii) and optionally iii) to form a pre-polymer:
i) a compound of the Formula (1); 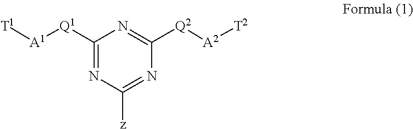
wherein:
T¹ and T² are each independently —OH, —SH or —NR¹H;
Q¹ and Q² independently are —NR²—;
A¹ and A² independently are an optionally substituted divalent organic linking group;
z is a halogen;
R¹ when present is H or an optionally substituted alkyl, aryl or heterocyclyl group;
R² is H or an optionally substituted alkyl, aryl or heterocyclyl group;
ii) a diisocyanate;
iii) an isocyanate-reactive compound;
and then reacting the pre-polymer with at least component iv):
iv) one or more compounds selected from an organic amine, alcohol or thiol provided that at least one of the said one or more organic compounds in component iv) has at least one ionic group;
wherein the particulate solid is surface-modified with ionic groups and/or the particulate solid has situated on its surface one or more second polymers which is/are different from the first polymer.

2. A dispersion according to claim 1 wherein at least 0.1 wt % of the first polymer relative to the dispersion is present freely in the liquid vehicle and is not associated with the particulate solid.

3. A dispersion according to claim 1 comprising from 0.1 to 20 wt % of the first polymer.

4. A dispersion according to claim 1 wherein the particulate solid is surface-modified with ionic groups selected from sulfonic acid, carboxylic acid and phosphorus-containing acid groups.

5. A dispersion according to claim 1 wherein the ionic groups in component iv) are selected from sulfonic acid, carboxylic acid and phosphorus-containing acid groups.

6. A dispersion according to claim 1 wherein the second polymer(s) are not ethoxylated acetylenic diols.

7. A dispersion according to claim 1 wherein the second polymer is a polytriazine which is free from urethane linkages, a polyamide, a polyurethane which is free from triazine linkages, a polyester, a polyvinyl polymer or a polymer comprising two or more thereof.

8. A dispersion according to claim 7 wherein the second polymer is a vinyl polymer derived from polymerising ethylenically unsaturated acrylic and/or styrenic monomers.

9. A dispersion according to claim 1 wherein the second polymer is cross-linked so as to encapsulate the particulate solid.

10. A dispersion according to claim 1 wherein the weight ratio of the first polymer to the second polymer is from 1:20 to 20:1.

11. A dispersion according to claim 1 wherein the particulate solid is a pigment.

12. A dispersion according to claim 1 wherein the dispersion comprises from 0.1 to 20 wt % of the first polymer, at least 0.1 wt % of the first polymer relative to the weight of the dispersion is present freely in the liquid vehicle and is not associated with the particulate solid, the second polymer is a vinyl polymer derived from polymerising ethylenically unsaturated acrylic and/or styrenic monomers, the ionic groups in component iv) are selected from sulfonic acid, carboxylic acid and phosphorus-containing acid groups, the weight ratio of the first polymer to the second polymer is from 1:20 to 20:1, the second polymer is cross-linked so as to encapsulate the particulate solid and the particulate solid is a pigment.

13. An ink comprising a dispersion according to claim 1.

14. An ink comprising a dispersion according to claim 12.

15. An ink jet printer cartridge comprising a chamber and an ink, wherein the ink is present in the chamber and the ink is as defined in claim 13.

16. An ink jet printer cartridge comprising a chamber and an ink, wherein the ink is present in the chamber and the ink is as defined in claim 14.

17. A process for preparing a dispersion or ink according to claim 1 comprising combining the components a) and b):
a) a first polymer;
the first polymer being obtained by a process comprising reacting at least the components i), ii) and optionally iii) to form a pre-polymer:
i) a compound of the Formula (1); 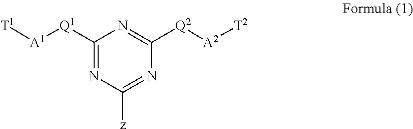
wherein:
T¹ and T² are each independently HO—, HS— or HNR¹—;
Q¹ and Q² independently are —NR²—;
A¹ and A² independently are an optionally substituted divalent organic linking group;
Z is a halogen;
R¹ when present is H or an optionally substituted alkyl, aryl or heterocyclyl group;
R² is H or an optionally substituted alkyl, aryl or heterocyclyl group;
ii) a diisocyanate;
iii) optionally an isocyanate-reactive compound;
and then reacting the pre-polymer with at least component iv):
iv) one or more compounds selected from an organic amine, alcohol or thiol provided that at least one of the organic compounds in component iv) has at least one ionic group; and
b) a dispersion comprising a particulate solid and a liquid vehicle wherein the particulate solid is surface-modified with ionic groups and/or the particulate solid has situated on its surface one or more second polymers which is/are different from the first polymer.
